(19) United States
(12) Patent Application Publication
(10) Pub. No.: US 2007/0299755 A1
(43) Pub. Date: Dec. 27, 2007

(54) PURCHASE CARD PERFORMANCE SYSTEM

(75) Inventor: Terence M. Carr, Cincinnati, OH (US)

Correspondence Address: FROST BROWN TODD, LLC, 2200 PNC CENTER, 201 E. FIFTH STREET, CINCINNATI, OH, 45202, US

(73) Assignee: RINA Systems, Inc., Cincinnati, OH (US)

(21) Appl. No.: 11/780,887

(22) Filed: Jul. 20, 2007

Related U.S. Application Data
(63) Continuation-in-part of application No. 10/340,296, filed on Jan. 10, 2003.

(51) Int. Cl. G06Q 40/00

(52) U.S. Cl. 705/35

(57) ABSTRACT

A Purchase Card Maximization apparatus, method, and program product enhances efficiencies realized by an organization through (1) Performance Metrics And Reporting by analyzing applicable purchases through a cost center hierarchical display, measuring performance against baseline targets, highlighting areas in need of improvement, and providing reports that list specific steps to improve purchase card program performance; (2) Usage Compliance by applying specific company policy regulations to current purchase card transactions, record and track violations of company policies by cardholders and organization, automatically providing email notification of violations to cardholders, and providing escalation policy for dealing with repeat offenders; and (3) Audit Implementation And Tracking by applying a specific company policy to determine cardholders to be audited, recording and tracking results of cardholder audits, ensuring due diligence in applying audit strategy, and reporting overall program compliance through audit reporting.

### CROSS REFERENCE TO RELATED APPLICATIONS

This application is a continuation-in-part and claims priority from U.S. Ser. No. 10/340,296, filed Jan. 10, 2003.

### FIELD OF THE INVENTION

This invention relates to a system and method for monitoring organizational use of an adjudicated third party payment at the point of service (e.g., purchase card) in lieu of more elaborate procurement channels, and more particularly, to a system and method for analyzing performance metrics, usage compliance, and audit implementation and tracking for organizational purchase card programs.

### BACKGROUND OF THE INVENTION

Private and governmental institutions (“sponsors”) are increasingly turning to purchase card programs that are accepted by vendors in the same manner as credit cards. Purchase cards have the advantage of quickly effecting the transfer of funds and lend themselves to use in person, over the Internet, faxed order forms, and telephone orders. The purchase card transaction is greatly simplified over traditional procurement transactions requiring a purchase order, invoice, and payment or similar procedure.

Vendors throughout the world accept purchase cards without question because they are familiar with commercial credit cards and they understand how to accept them. The account holders of a purchase card benefit by being able to decide what to purchase, when to buy it, and from whom, and can monitor funds availability. The sponsor of the account holders benefits by saving time, money and resources, especially for low dollar value, high-volume procurements made with purchase cards.

Accountability for usage of the purchase card is often managed by the third-party facilitator that issues the purchase cards and mediates the transactions between vendors and sponsors that use the purchase cards. For instance, the purchase card is often not a revolving credit card, but rather works as a debit card with a dollar amount fixed to the card, which is reduced by the amount of each purchase. If the cost of the item exceeds the balance on the card, the transaction cannot be completed. There may also be restrictions on the use of the purchase card, which reflect the account's budget and the sponsor's restrictions, if any. The third-party facilitators for purchase accounts also provide transaction summaries that are also useful for the organizations to review and audit to avoid misuse of the purchase cards.

Much development has occurred in the handling of credit card and purchase card transactions. Purchasing Card (“PCard”) programs have provided documented gains in productivity and effectiveness for organizations that utilize them. Implementing a Purchasing Card program in an organization, however, can be a difficult task for the administrator as it deals with change in many areas of the business where the administrator has no control. The sponsors often have inadequate insight into the use of the purchase card with regard to traditional procurement channels, especially when seeking to identify groups or individuals that are under- or over-utilizing their purchase card.

Consequently, a significant need exists for an approach for giving a sponsor organization insight into the use of their purchase card by cost centers in order to optimize the economic savings thereof and to better utilize purchase card capabilities throughout the organization while achieving greater control over the use of the purchase card.

### BRIEF SUMMARY OF THE INVENTION

The invention overcomes the above-noted and other deficiencies of the prior art by providing a Purchase Card Maximization method, apparatus, and program product that interactively analyzes purchasing decisions made during the period in analysis, thereby evaluating the efficiency of a purchasing function of an organization and identifying areas for improvement, and also advantageously performing auditing and compliance verification functions.

In one aspect of the invention, purchase account transactions of an organization having a plurality of account holders authorized to perform purchase account transactions and traditional procurement transactions are analyzed to determine a value of traditional procurement transactions, to determine a value of purchase account transactions, and to calculate a performance measure based on the values of the traditional procurement transactions and purchase account transactions. Thereby, a clear metric may be applied to cardholders and cost centers of an organization to better manage use of purchase accounts.

In another aspect of the invention, a method is described that includes associating account holder records to one of a number of hierarchically related cost centers, receiving purchase account transactions and traditional procurement transactions for the account holders and calculating a performance measure for each cost center based on the assigned values of the traditional procurement transactions and purchase account transactions. Thereby, the typical hierarchical nature of an organization and the large number of account holders are handled in a way that is meaningful for analysis.

A major benefit of the use of the Purchase Card Maximization method is an increase in the number of transactions put on the card. Other benefits include time savings for a Program Administrator, rebates if the amount on the card reaches a certain amount, better control, easier communication within the organization, convenience, good look and feel, etc.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a diagram of a hardware environment of an enterprise system for procurement and accounting processing having a purchase card maximization capability.

FIG. 2 is a diagram of a software environment of the purchase card maximizer of FIG. 1.

FIG. 3 is an object oriented language class diagram for the data structures used by the purchase card maximizer of FIGS. 1 and 2 for uploading transaction data.

FIG. 4 is an object oriented language class diagram for the data structures used by the purchase card maximizer of FIGS. 1 and 2 for report creation.

FIG. 5 is an object oriented language class diagram for the data structures used by the purchase card maximizer of FIGS. 1 and 2 for generating a on account holder (cardholder) activities.

FIG. 6 is an object oriented language class diagram for the data structures used by the purchase card maximizer of FIGS. 1 and 2 for data processing and report preparation.

FIG. 7 is an object oriented language class diagram for the data structures used by the purchase card maximizer of FIGS. 1 and 2 for supporting data.

FIG. 8 is a sequence of operation of the purchase card maximizer of FIGS. 1 and 2 for analyzing performance metrics, usage compliance, and audit implementation and tracking for organizational purchase card programs.

FIG. 9 is a diagram depiction of a user interface to the purchase card maximizer of FIGS. 1 and 2 for configuration management.

FIG. 10 is a diagram depiction of a user interface to the purchase card maximizer of FIGS. 1 and 2 for data processing.

FIG. 11 is a diagram depiction of a user interface to the purchase card maximizer of FIGS. 1 and 2 for the end-of-cycle tasks of entering audit results.

FIG. 12 is a diagram depiction of a user interface to the purchase card maximizer of FIGS. 1 and 2 for the reporting task of analyzing performance by cost center.

FIG. 13 is a diagram depiction of a user interface to the purchase card maximizer of FIGS. 1 and 2 for the reporting task of analyzing potential vendors for purchasing card use.

FIGS. 14a-14b show an example of an interface which might be presented to a user to allow rules to be defined by modifying parameters in a library of pre-existing rules.

FIGS. 15a-15b depict an interface which can be used to model the effects of a rule without putting the rule into place.

FIG. 16 depicts an interface which could be used to provide the results of a test.

FIGS. 17a-17b depict an interface which could be used to select one or more questions.

FIGS. 18a-18b depict an interface which could be used to select one or more actions.

### DETAILED DESCRIPTION OF THE INVENTION

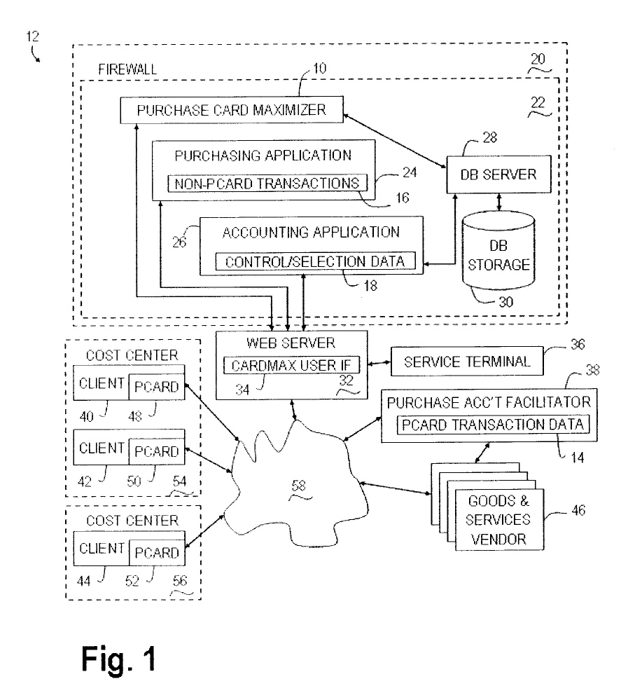

In FIG. 1, a purchase card maximization system 10 (“CardMax system”) is to provide an easy to use, standardized method to measure and report the performance of a purchasing card (“PCard”) operation within in enterprise network 12. Through the use of common web-based technologies, it measures the purchases of an organization to determine the percentages of applicable purchases made on the PCard versus those made through other means. By doing this, the CardMax system 10 is able to show not only the purchases that were made on the PCard, but also, the missed opportunity of purchases that could have been made on the PCard, by parts of an organization, types of purchases, and specific vendor candidates.

There are three primary sources of data for the CardMax system 10. PCard Purchasing Data (“PCard Transaction Data”) 14 that provides a list of purchases made during a specific period. Generally the PCard transaction data 14 includes the date of purchase, the vendor, the amount and the identifying codes (e.g. Cost center) used by the organization. The second source of data is General Ledger (GL) Accounting Data, or “non-PCard transaction data” 16, that provides a list of expenses logged during a specific period that includes the date of expense, the vendor, the amount and identifying information about the expense. The third source of data is Control/Selection Data 18 that provides a list of codes that should be accepted as valid categories of expenses and lists of cost centers and cardholders by which to group transactions. The GL Accounting Data 16 may include many types of expenses that may not be applicable to PCard purchases, which may be filtered by the control/selection data 18 so that only applicable expenses are included and analyzed.

The enterprise network 12 is illustrative of an organization having a segregated procurement and accounting system 20 that includes a firewall-protected portion 22. The non-PCard transaction data 16 resides in the firewall-protected portion 22 upon a purchasing application 24 used for procurement actions. The control/selection data 18 resides within an accounting application 26 that is also within the firewall protected portion 22. The purchase card maximizer 10 also resides within the firewall-protected portion 22. Each of the applications 10, 20, 26 interface to a database (DB) server 28 and hence to a DB storage medium 30, both of latter also residing in the firewall protected portion 22.

The illustrative depiction of FIG. 1 depicts a decentralized architecture wherein the procurement and accounting system 20 is interfaced to an external web server 32, which includes a CardMax user interface (IF) 34. A customer interfaces to the CardMax user interface 34 via a service terminal 36 in order to perform function such as uploading the purchase card transaction data 14 from a purchase account facilitator 38 (e.g., a financial institution). The purchase account facilitator 38 mediates and tracks purchases made by a plurality of account holders (“client”) 40-44 with a number of vendors 46 that provide goods and services. Each account holder 40-44 has a respective purchase account (“PCard”) 48-52. Within the organization, the account holders 40-44 may be advantageously grouped into Cost Centers 54, 56, enabling analysis of management and efficiency of various subgroups.

The interactions between account holders 40-44, vendors 46, the customer service terminal 36, and the web server 32 are depicted as passing through a communication network 58, which may include or comprise in its entirety one or more of a digital network (e.g., Internet), telephone network, wireless network, local area network, wide area network, and other means apparent to those skilled in the art having benefit of the present disclosure.

The customer (e.g., CardMax administrator) is able to configure the purchase card maximizer 10 through the service terminal 36, such as selecting data formats, excluding certain vendors from analysis, creation of certain data extracts. The CardMax administrator is also able to generate performance reports for a given time frame, showing by demographic group the amount and number of purchases made through the purchasing card and those made through other means. They will make it easy to highlight areas of the organization that are effectively using the purchasing card and those that have opportunity for improvement. The CardMax administrator is also able to generate improvement reports for an area of the organization, specifying actions that can be made in the future to improve PCard performance. It will also be appreciated that comparisons may be made between different organizations for benchmarking purposes. This capability enables comparisons by demographics, such as type of industry or length of time the PCard program has been implemented.

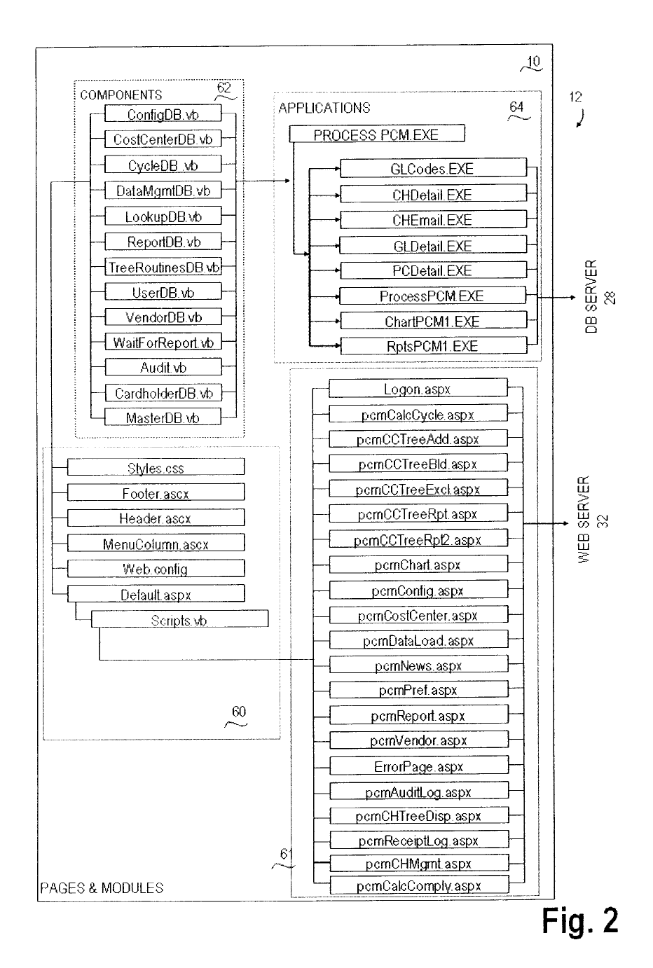

In FIG. 2, an exemplary “.Net” implementation is depicted for the purchase card maximizer 10, including pages and modules 60 that interface to the web server 32 components 62 coupled to the pages and modules 60, and applications 64 coupled to the components 62 and to the DB server 28.

The pages and modules 60 and 61 include hypertext pages implemented in ASP+ (also called ASP.NET), which is the next generation of Microsoft's Active Server Page (ASP), a feature of their Internet Information Server (IIS). Both ASP and ASP+ allow a Web site builder to dynamically build Web pages on the fly by inserting queries to a relational database in the Web page. ASP+ is different than its predecessor in two major ways: it supports code written in compiled languages such as Visual Basic, C++, C#, and Perl, and it features server controls that can separate the code from the content, allowing WYSIWYG editing of pages. Although ASP+ is not backward compatible with ASP, it is able to run side by side with ASP applications. ASP+ files can be recognized by their .aspx extension. The pages and modules 60 include a Web.config ASP.NET configuration file that contains configuration data on each unique URL resource used in the project.

A Default.aspx page is a welcome page with the short description of the tools and methodology to analyze the performance of the purchase card program. Interface controls are accessed from the Default.aspx page, specifically Scripts.vb, a simple data class that contains support functionality for the user interface, and a Styles.css Styles Class that contains information used for support the style of the user interface. A Footer.ascx User control is used to display copyright line at the bottom of all Web pages. A Header.ascx User control is used to display header information at the top of all Web pages. This control is also responsible for creating submenu information corresponding to each Web page. A MenuColumn.ascx User control is used to display menu information.

The scripts.vb data class in turn accesses a number of sub-pages: A Logon.aspx Page Class is used to authenticate a customer's supplied User name/password credentials against a database. A pcmCalcCycle.aspx Page Class is used to calculate purchase card performance for the chosen cycle. A pcmCCTreeAdd.aspx Page Class is used to add a new Cost Center to the Cost Center Hierarchy. A pcmCCTreeBld.aspx Page Class is used to set a Cost Center Hierarchical display. A pcmCCTreeExcl.aspx Page Class is used to exclude Cost Centers that are not participating in the purchase card program for the cycle. A pcmCCTreeRpt.aspx Page Class is used to display Cost Center performance by analyzing applicable purchases through a Cost Center Hierarchy. A pcmCCTreeRpt2.aspx Page Class is used to display and compare Cost Center performance for the two different cycles. A pcmChart.aspx Page Class is used to display purchase card performance charts for the chosen Cost Center from a Cost Center hierarchy. A pcmConfig.aspx Page Class is used to give user ability display and change configuration parameters, add new cycle and update existing cycle. pcmCostCenter.aspx Page Class is used to display filtered Cost Center list in order to update it. A pcmDataLoad.aspx Page Class is used to perform initial data load, load list of Valid GL Codes, load GL data for Cycle, load purchase card transactions data for Cycle. A pcmNews.aspx Page class is used to provide current news of interest to CardMax administrators. A pcmPref.aspx Page class provides controls for modifying the use interface. A pcmReport.aspx Page Class is used to display newly created purchase card reports or load existing reports. A pcmVendor.aspx Page Class is used to display filtered Vendor list in order to exclude/include vendors from/into purchase card program. An ErrorPage.aspx Page Class is used to return to the user information that invalid event has occurred. A pcmAuditLog.aspx Page Class is used to display filtered Cardholder list in order to analyze Cardholder's activity within predetermined Cycle period. A pcmCHTreeDisp.aspx Page Class is used to display Cardholder's activity through a Cost Center Hierarchy within predetermined Cycle period. A pcmReceiptLog.aspx Page Class is used to display filtered Cardholder list in order to obtain Logged/Non-Logged Receipts information. A pcmCHMgmt.aspx Page Class is used to manage and assign Cardholder information. A pcmCalcComply.aspx Page Class is used to calculate compliance measurements for a cycle.

The components 62 are implemented in Visual Basic (VB), which is a programming environment from Microsoft in which a programmer uses a graphical user interface to choose and modify preselected sections of code written in the BASIC programming language. A ConfigDB.vb Business/Data Logic Class encapsulates all data logic necessary to update/query Config table within the Purchase Card Maximizer (PCM) database in DB storage 30. A CostCenterDB.vb Business/Data Logic Class encapsulates all data logic necessary to add/update/query Cost Center Management tables within the PCM database. A CycleDB.vb-Business/Data Logic Class encapsulates all data logic necessary to add/query Cycle Management tables within the PCM database to generate cycle results. A DataMgmtDB.vb Business/Data Logic Class encapsulates all data logic necessary to add/update/query Data Management tables within the PCM database. A LookupDB.vb Business/Data Logic Class encapsulates all data logic necessary to add/update/query Lookup tables within the PCM database. A ReportDB.vb Report Logic Class encapsulates all data logic necessary to add/update/query Report tables within the PCM database. A TreeRoutinesDB.vb Business/Data Logic Class encapsulates all data logic necessary to create Cost Center Hierarchical display. A UserDB.vb simple data class encapsulates details about a particular PCM User. A VendorDB.vb Business/Data Logic Class encapsulates all data logic necessary to update/query Vendor tables within the PCM database. A WaitForReport.vb class module checks report status in order to display the report in needed format. An Audit.vb Business/Data Logic Class encapsulates all data logic necessary to perform analysis of the activity of groups of cardholders within predetermined cycle period. A CardholderDB.vb Business/Data Logic Class encapsulates all data logic necessary to analyze the information about cardholder's activity. A MasterDB.vb Business/Data Logic Class encapsulates all data logic necessary to navigate a user to their specific instance of the CardMax database. The applications 64 include programs that effect the preparation of the analyses. A GLCodes.exe application loads a list of valid GL Codes into the PCM database. A CHDetail.exe application loads Cardholder Data into the PCM database. A CHEmail.exe application loads Cardholder Email Addresses into the PCM database. A GLDetail.exe application loads GL Data for the cycle into the PCM database. A PCDetail.exe application loads purchase card transaction data for the cycle into the PCM database. A ProcessPCM.exe application detects and executes any request from the user to load data into the PCM database, to create reports, or to create charts. A ChartPCM1.exe application creates purchase card performance charts and stores them in the PCM database in JPG format. A RptsPCM1.exe application creates purchase card performance reports and store them in the PCM database in PDF format.

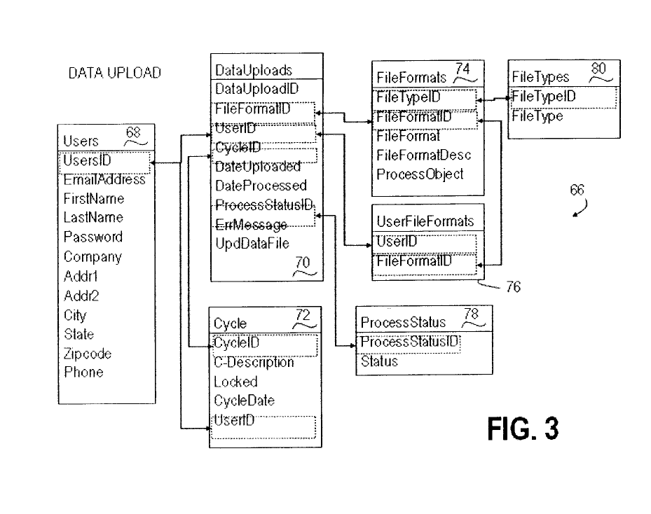

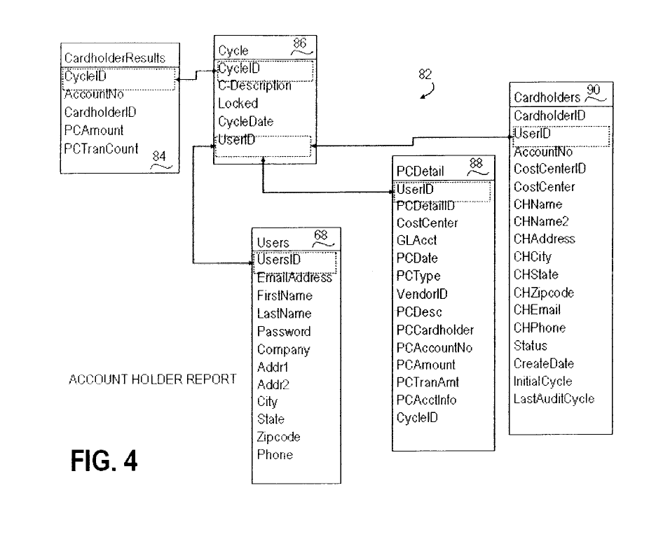

FIGS. 3-7 depict relationships between tables and fields used respectively to upload purchase account transactions, prepare account holder reports, create a report, to support company specific interfaces and preferences, and data processing and report preparation. In FIG. 4, a data download capability 66 includes a Users table 68 (having fields UsersID, EmailAddress, FirstName, LastName, Password, Company, Addr1, Addr2, City, State, Zipcode, and Phone) that is linked via key field UserID to DataUploads table 70 (having fields DataUploadID, FileFormatID, UserID, CycleID, DateUploaded, DateProcessed, ProcessStatusID, ErrMessage, and UpdDataFile). The Users table 68 is linked via key field UserID and DataUploads table 70 is linked via key field CycleID to a Cycle table 72 (having fields CycleID, C-Description, Locked, CycleDate, and UserID). The DataUploads table 70 is linked via key field FileFormatID to a FileFormats table 74 (having fields FileTypeID, FileFormatID, FileFormat, FileFormatDesc, and ProcessObject). The DataUploads table 70 is linked via key field UserID to a UserFileFormats table 76 (having fields UserID and FileFormatID). The DataUploads table 70 is linked via key field CycleID to a ProcessStatus table 78 (having fields ProcessStatusID and Status). The FileFormats table 74 is linked via key field FileTypeID to a FileTypes table 80 (having fields FileTypeID and FileType).

In FIG. 4, an account holder report capability 82 includes a CardholderResults table 84 (having fields CycleID, AccountNo, CardholderID, PCAmount, and PCTranCount) is linked via key field CycleID to a Cycle table 86 (having fields CycleID, C-Description, Locked, CycleDate, and UserID). The Cycle table 84 is linked via key field UserID to the Users table 68, to a PCDetail table 88 (having fields UserID, PCDetaillID, CostCenter, GLAcct, PCDate, PCType, VendorID, PCDesc, PCCardholder, PCAccountNo, PCAmount, PCTranAmt, PCAcctInfo, and CycleID), and to a Cardholders table 90 (having fields UserID, AccountNo, CostCenterID, CostCenter, CHName, CHName2, CHAddress, CHCity, CHState, CHZipcode, CHEmail, CHPhone, Status, CreateDate, InitialCycle, and LastAuditCycle).

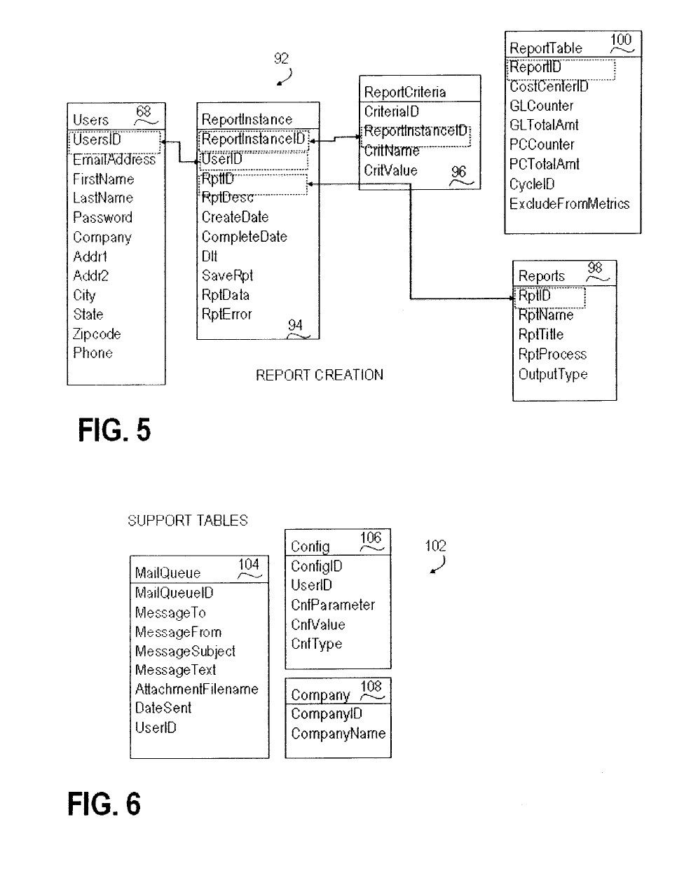

In FIG. 5, a report creation capability 92 is achieved by linking the Users table 68 via key field UserID to a ReportInstance Table 94 (having fields ReportInstanceID, UserID, RptID, RptDesc, CreateDate, CompleteDate, DIt, SaveRpt, RptData, RptError). The ReportInstance Table 94 is linked via keyfield ReportInstanceID to a ReportCriteria table 96 (having fields CriteriaID, ReportInstanceID, CritName, and CritValue). The ReportInstance table 94 is also linked via a keyfield RptID to both a Reports table 98 (having fields RptID, RptName, RptTitle, RptProcess, and OutputType) and to a ReportTable table 100 (having fields ReportID, CostCenterID, GLCounter, GLTotalAmt, PCCounter, PCTotalAmt, CycleID, and ExcludeFromMetrics).

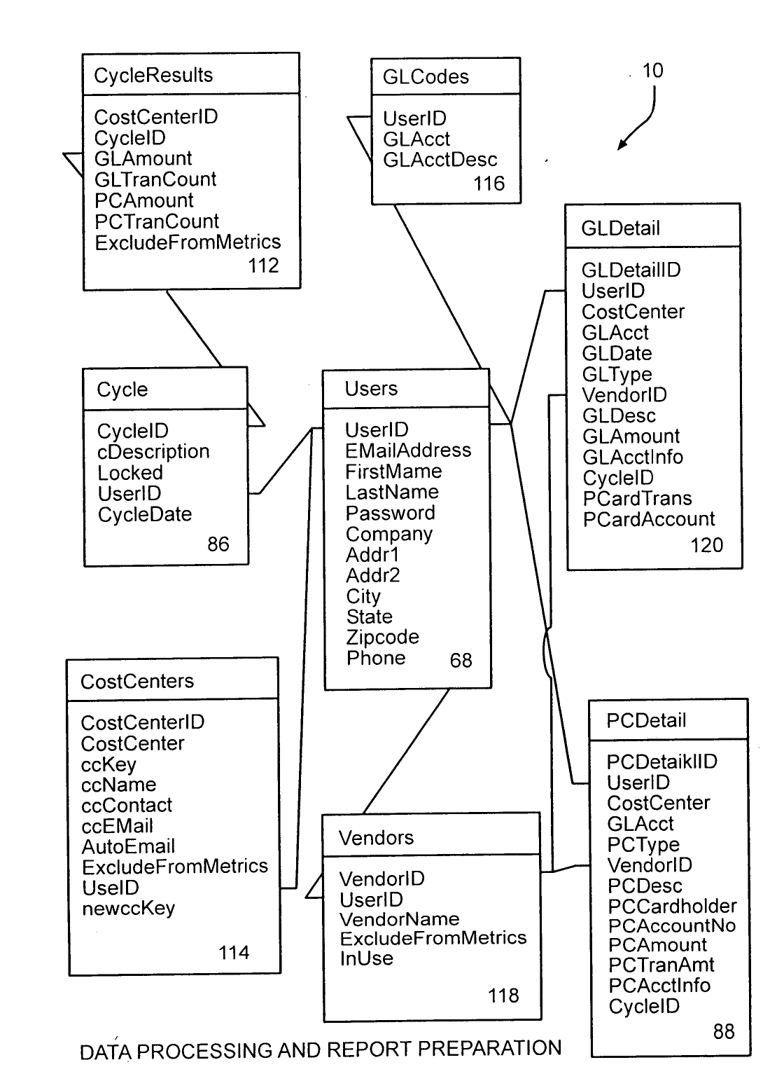

In FIG. 6, a support table capability 102 includes a MailQueue table 104 (having fields MailQueueID, MessageTo, MessageFrom, MessageSubject, MessageText, AttachmentFilename, DateSent and UserID) for managing automail distribution of reports. A Config table 106 (having fields ConfigID, UserID, CnfParameter, CntValue and CnfType) stores individual configurations for each CardMax administrator. A Company table 108 (having fields CompanyID and CompanyName) allows an installation of Cardmax system 10 to service multiple organizations.

In FIG. 7, a data processing and report preparation capability 110 is depicted. The Users table 68 is linked via key field UserID to the Cycle table 86, which in turn is linked to a CycleResults table 112 (having fields CostCenterID, CycleID, GLAmount. GLTranCount, PCAmount, PCTranCount, and ExcludeFromMetrics). The Users table 68 is also linked to a CostCenters table 114 (having fields CostCenterID, CostCenter, ccKey, ccName, ccContact, ccEMail, AutoEmail, ExcludeFromMetrics, UserID, and newccKey), to a GLCodes table 116 (having fields UserID, GLAcct, and GLAcctDesc), to a Vendors table 118 (having fields VendorID, UserID, VendorName, ExcludeFromMetrics, and InUse), to the PCDetail table 88, and to a GLDetail table 120 (having fields GLDetailID, UserID, CostCenter, GLAcct, GLDate, GLType, VendorID, GLDesc, GLAmount, GLAcctInfo, CycleID, PCardTrans, and PCardAccount). The Vendors table 118, the GLDetail table 120, and the PCDetail table 88 are also linked to one another by key field VendorID.

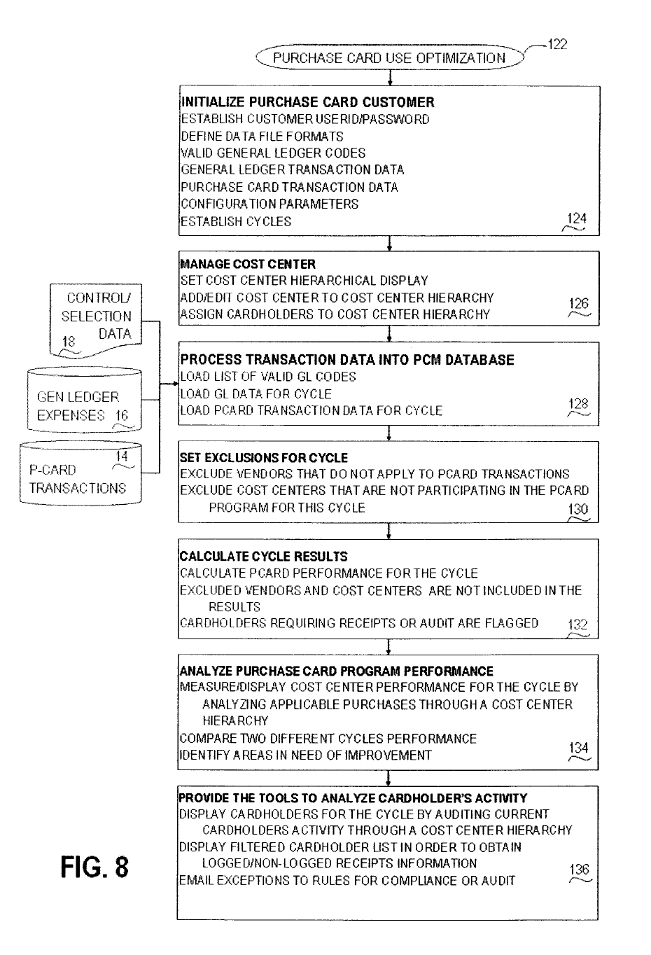

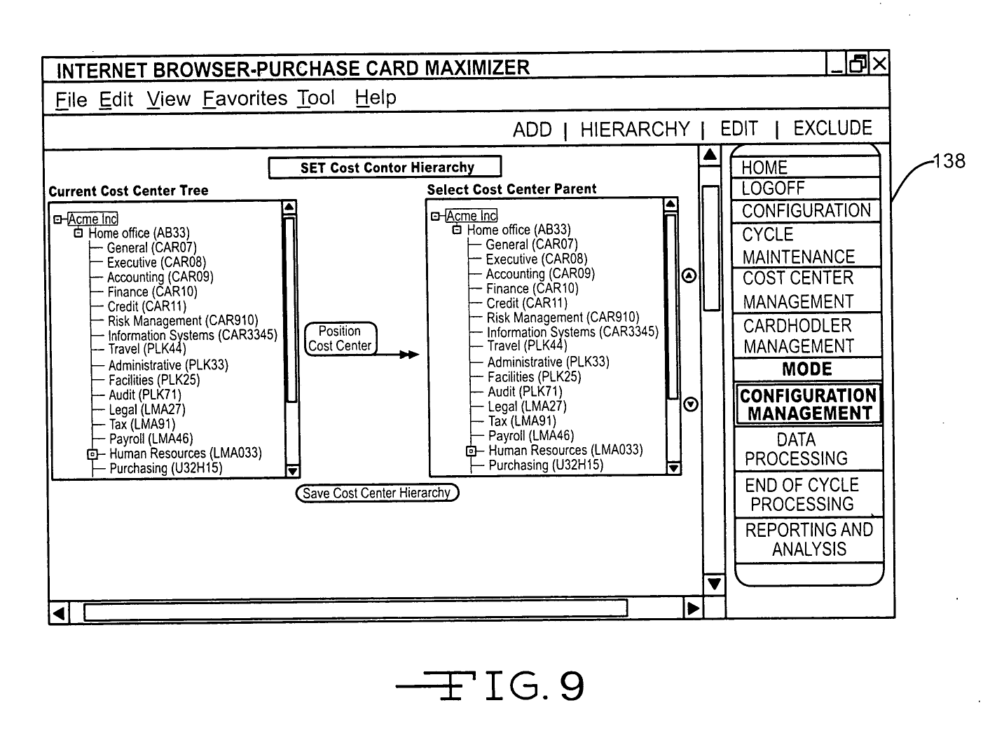

In FIG. 8, a sequence of operations, or procedure 122, is depicted for purchase account use optimization, an illustrative use of the PCard maximizer 10 of FIGS. 1-2 to analyze the use of purchase accounts. In block 124, the purchase card customer is initialized in the system, which advantageously includes establishing a customer user ID and password, defining a data file formats that is to be used in merging transaction data, identifying valid general ledger codes for the types of transactions to be analyzed, initializing storage locations for transaction data to be received (e.g., non-purchase account transactions, purchase account transactions), setting configuration parameters for the user interface, and establishing the analysis cycles.

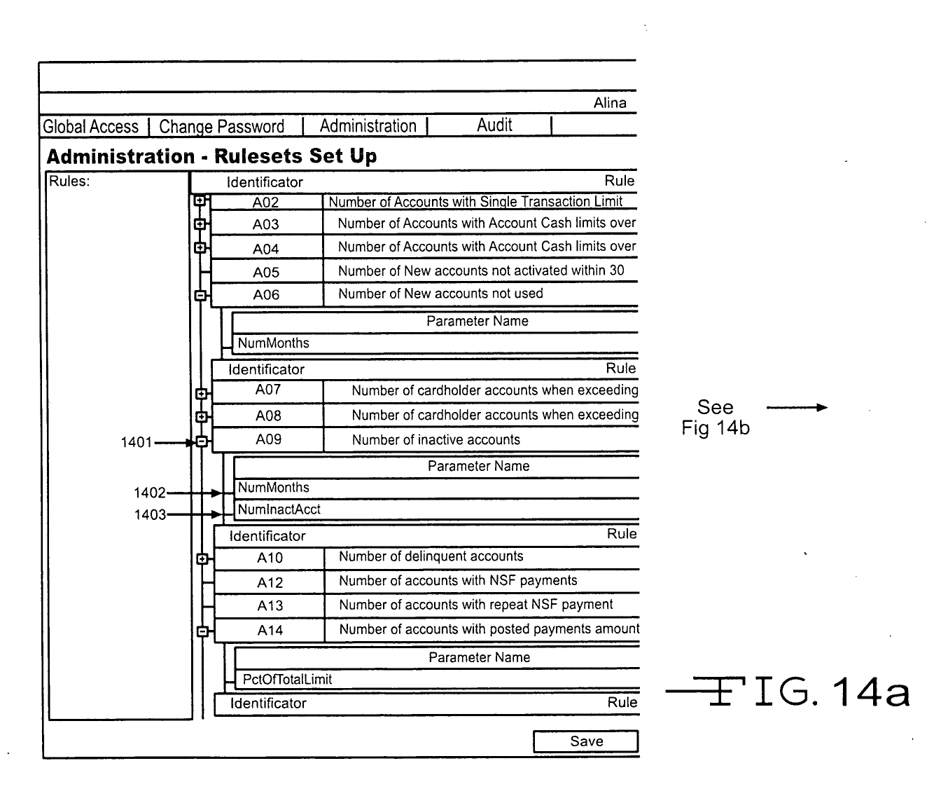

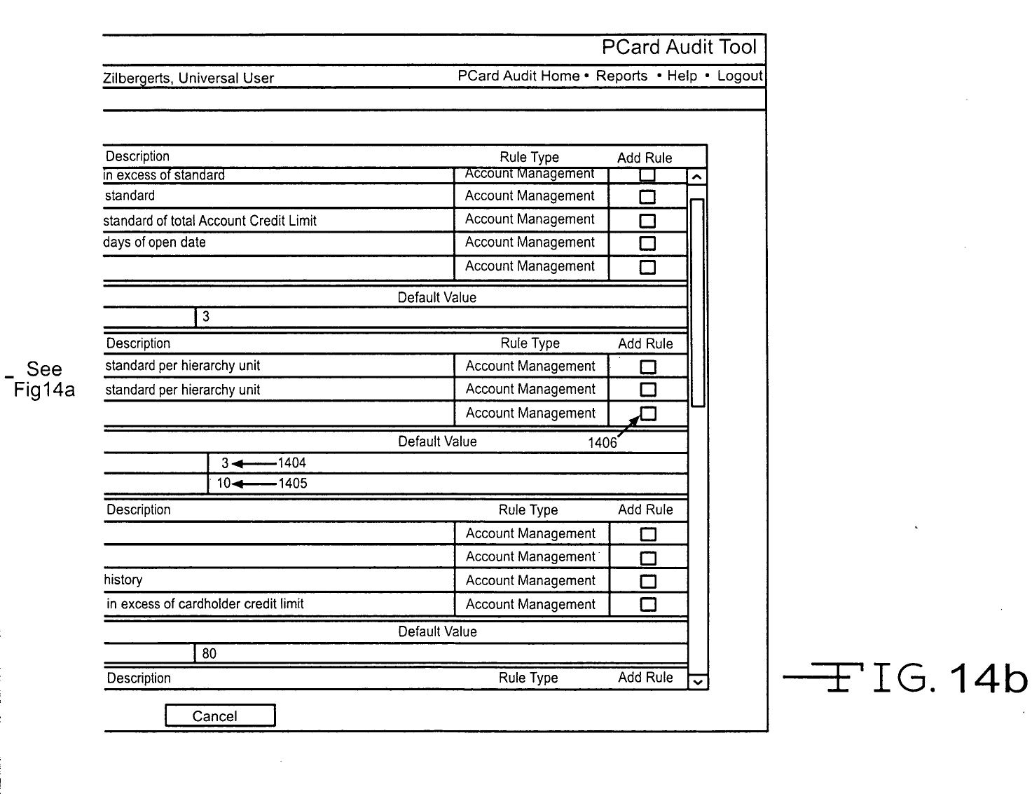

Additionally, in some situations, a PCard maximizer 10 might be configured to gather data related to audits of purchase card transactions, and the software used in the step of initializing a purchase card customer into the system 124 might be implemented in such a way as to facilitate the gathering of audit data. For example, in some situations a user might be presented with an interface which allows the user to define a plurality of rules which could be used in audits of purchase card transactions. Such rule definition might take place in a variety of manners. FIGS. 14a and 14b show an example of an interface which might be presented to a user to allow rules to be defined by modifying parameters in a library of pre-existing rules. In FIGS. 14a-14b, a plurality of rules (shown as rules A1-A14 in FIG. 14a) are displayed for the user to potentially modify and/or use. To modify a rule the user would click on the expansion control [1401] for the rule and be presented with a list of parameters [1402][1403] which control that rule's operation. In FIG. 14b, the parameters [1402][1403] are shown as having default values [1404][1405] which can be modified as appropriate by the user. Once the parameters [1404][1405] had been edited appropriately, or if the user wishes to activate the rule without changing the parameters, an activation control [1406] for the rule could be selected, thereby indicating that the rule should be used in future audits with the given parameters. Of course, it should be understood that the interface as shown in FIGS. 14a and 14b is intended to be illustrative only of one potential interface which could be presented, and therefore should not be treated as limiting on claims included in this application, or in other applications claiming the benefit of this application.

As a potential extension on the interface depicted in FIGS. 14a-14b, consider a situation in which rules are segmented according to category. As an example of such segmentation, consider that the rules shown in FIGS. 14a-14b are identified as having the type of “account management,” which should be understood as meaning rules which are used to audit the organization sponsoring the purchase card program. Other categories which might be used to segment rules include “transactional,” which should be understood as meaning rules which are used to audit particular transactions in the purchase card program and “cardholder,” which should be understood as meaning rules which are used to audit individual cardholders participating the purchase card program. Such a categorization could then be presented to a user, who could choose which type of rule he or she wishes to define, thereby facilitating finding the correct rule in a library of predefined rules. Of course, it should be understood that the description of the use of rule categories is not intended to be limiting on the scope of techniques which can be used to facilitate the definition of rules, and that other techniques and tools could be implemented by those of ordinary skill in the art without undue experimentation in light of this disclosure.

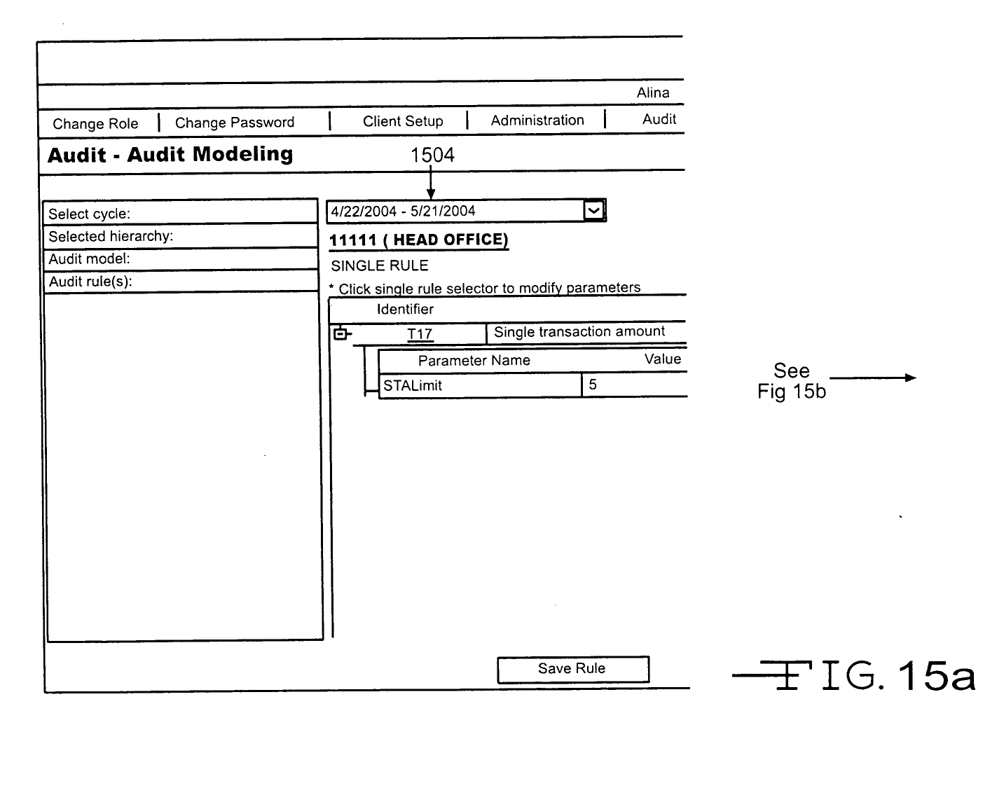

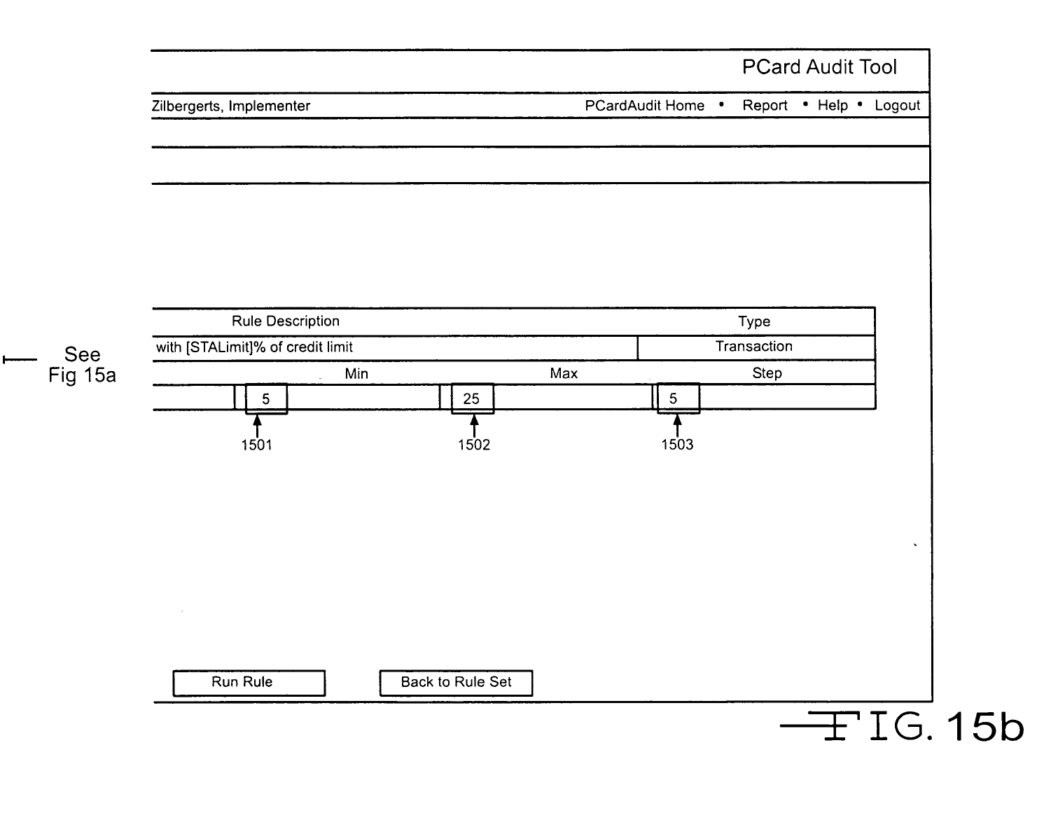

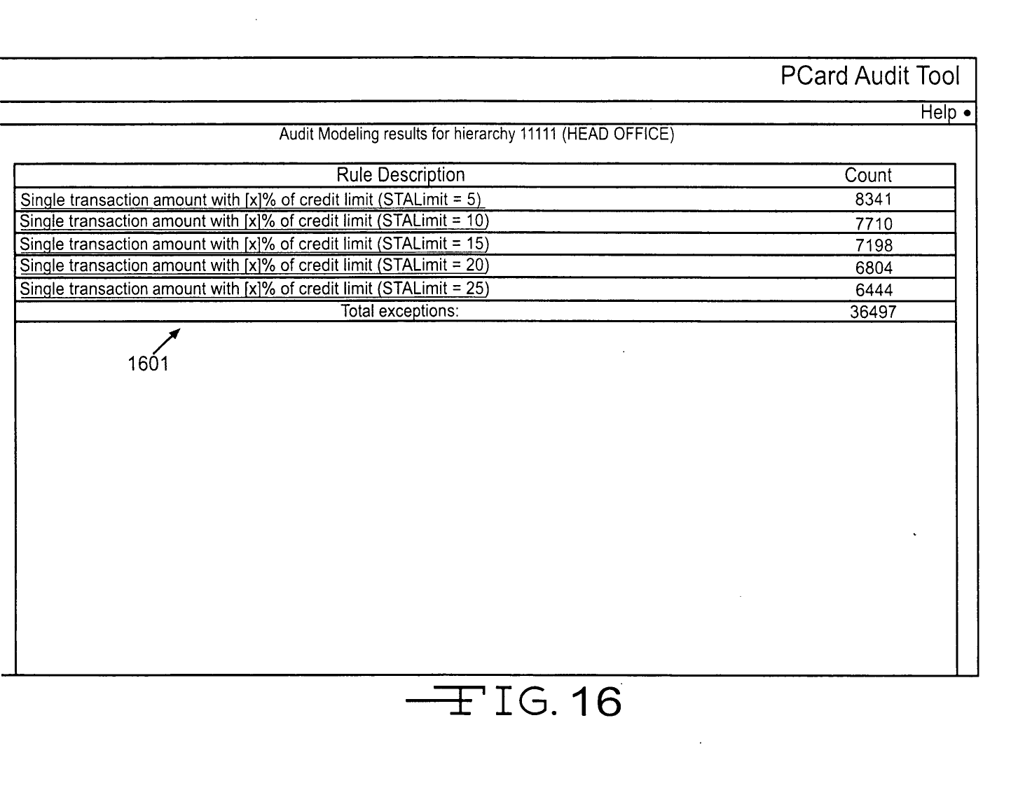

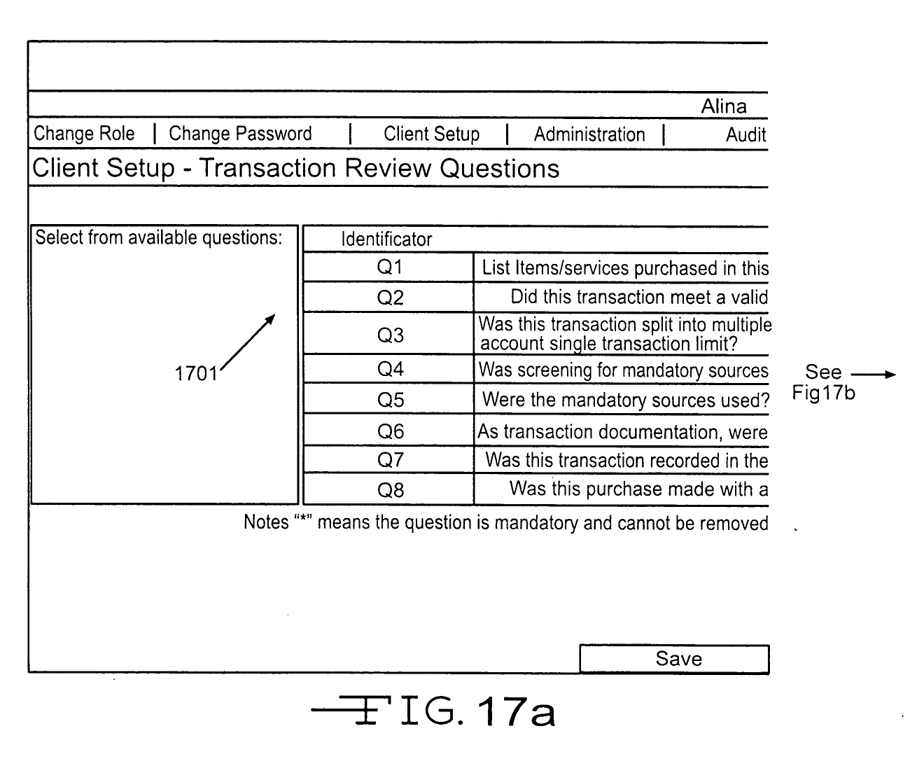

As an example of another tool which could potentially be used to facilitate the process of rule definition, consider the interface shown in FIGS. 15a-15b and 16. FIGS. 15a and 15b depict an interface which can be used to model the effects of a rule without putting the rule into place. Using the interface of FIGS. 15a-15b, a user can define a range through which to test various values for the parameter of a rule, and at what granularity and in what time period the user wishes to perform the tests. Specifically, FIG. 15b depicts a minimum value [1501] which is the smallest value in the range which the user wishes to test the parameter. FIG. 15b also depicts a maximum value [1502] and a step value [1503] which are, respectively, the values for the largest value in the range which the user wishes to test the parameter, and the granularity with which the user wishes to test the parameter. FIG. 15a also depicts a time frame [1504] to use as a data set for testing the parameter. Thus, the values of the interface shown in FIGS. 15a-15b could be used to indicate that the user wishes to see what would happen if the rule T17 had been in effect during the selected time period, having parameter values between 5 and 25, increased in increments of 5. Then, a second interface [1601], such as shown in FIG. 16, could be presented to the user to indicate the results of the test. Using that information, the user can determine the appropriate value for the parameter, resulting in a rule which is able to catch suspect transactions, but which is not so easily triggered as to generate excessive false positive results. Of course, it should be understood that the interfaces of FIGS. 15a-b and 16 are depicted for the purpose of illustration only, and that alternate interfaces (e.g., an interface which combines the information presented on FIGS. 15a-b and 16) could be implemented without undue experimentation by one of ordinary skill in the art in light of this disclosure.

In block 126, cost centers are managed, which includes setting a hierarchical representation or display (e.g., relationships between cost centers), and modifying individual costs centers (e.g., adding, editing, or deleting). It will be appreciated that purchase account holders are assigned to cost centers as part of initializing or editing their information. It should also be appreciated that organizing the hierarchical representation in terms of cost centers is simply an exemplary form of organization, and that other hierarchies could also be defined. For example, in instances in which a PCard maximizer is implemented to facilitate auditing, the hierarchy could be defined in terms of the audit or organization, rather than in terms of cost centers. As such, there could be a hierarchy in which the positions in the hierarchy are determined by the organization chart of the sponsor of the purchase card program (e.g., department heads could be placed above managers, who could in turn be placed above employees). As another alternative, there could be a hierarchy in which positions on a hierarchy are assigned according to audit responsibilities (e.g., final reviewers might be placed above intermediate reviewers, who might be placed above auditors, who might be placed above the specific purchase cardholders they are responsible for). Further, in implementations where a PCard maximizer is used to facilitate audits, the hierarchy could be used to define the scope of rules. For instance, a rule applied to a node in the hierarchy might automatically be applied to that node and all descendants of that node. Of course, other variations, such as node by node rule definition and assignment could also be used. Thus, the description of a hierarchy determined by cost centers, and the description of the use of that hierarchy, should be understood as being illustrative only of possible applications for the techniques disclosed herein, and not limiting on the scope of claims included in this application, or in other applications claiming the benefit of this application.

In block 128, transaction data for the cycle to be processed and analyzed are uploaded into a PCM database. This uploading includes loading a list of valid general ledger (GL) codes from the control/selection data table 18. It also includes loading GL data (i.e., non-purchase account transactions) from the general ledger expenses database 16. It also includes loading purchase account transactions data for this cycle from the purchase account transactions database 14, which typically has been retrieved from a third party. In block 130, exclusions for the cycle are set, wherein cost centers or vendors that are not participating in participating in the purchase account operation are excluded in order to focus on transactions that are appropriate for analysis.

In block 132, purchase card performance of the organization for the cycle is calculated. The vendors that have been excluded are not included in the results. The cost centers that have been excluded are calculated, but are not included at reporting or charting time. With the amounts calculated, then in block 134, the purchase card program performance is analyzed. Advantageously, analyses may include measuring and displaying cost center performance for the cycle by analyzing applicable purchases through a cost center hierarchy, comparing performance across two different cycles, and highlighting areas of the organization in need of improvement.

In block 136, the cardholders' activity is analyzed, which advantageously may include displaying cardholders for the cycle by auditing current cardholders activity through a cost center hierarchy, and displaying filtered cardholder list in order to obtain Logged/Non-Logged Receipts information.

Of course, it should be understood that utilizing a PCard maximizer for auditing Logged/Non-Logged Receipts for cardholders organized into a hierarchy of cost centers is intended to be an illustration only of a potential application of the techniques described herein, and that other applications could be implemented by those of ordinary skill in the art without undue experimentation. For example, in some circumstances, a transaction audit rule might be defined which limits the types of vendors where a purchase card could be utilized (e.g., no purchases at adult entertainment facilities). In such a case, the vendors for each purchase card transaction could be categorized, with forbidden expenditures being flagged as audit violations. Similarly, it is possible that, instead of (or in addition to) auditing purchase card transactions, rules might be used to audit the structure of the organization sponsoring the purchase card program. For example, there might be an account management rule which states that no one cost center will have more than ten purchase card holders associated with it.

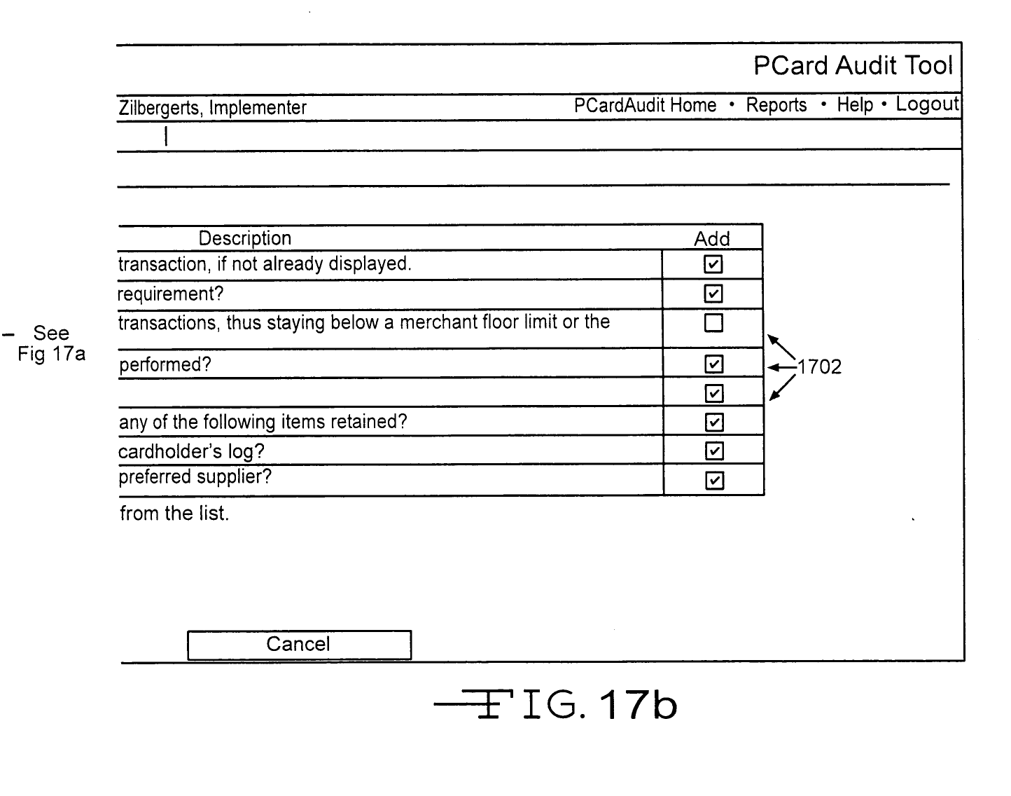

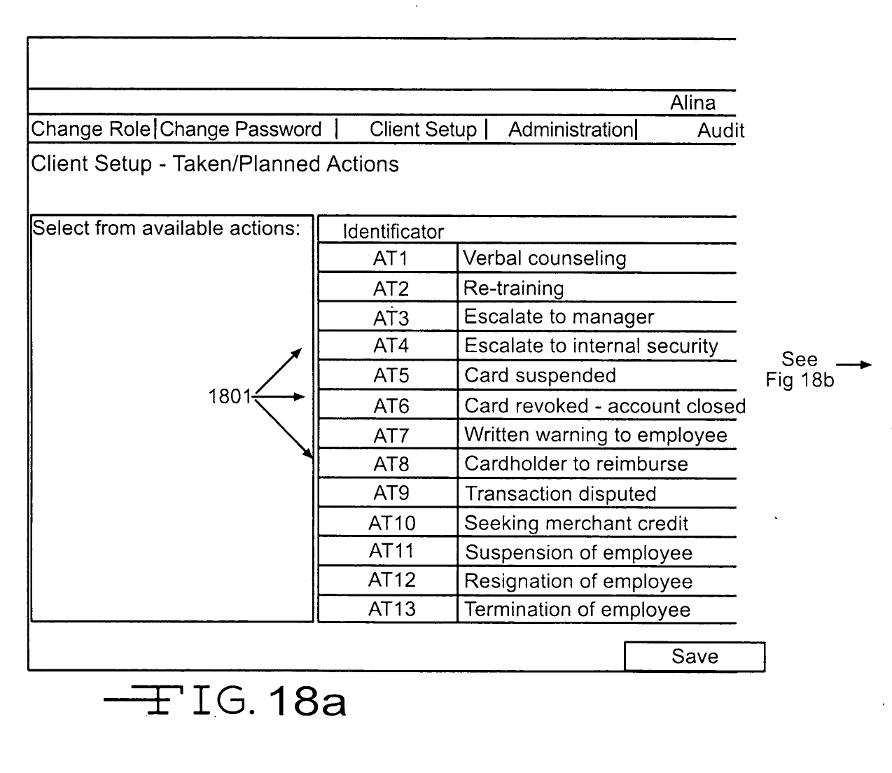

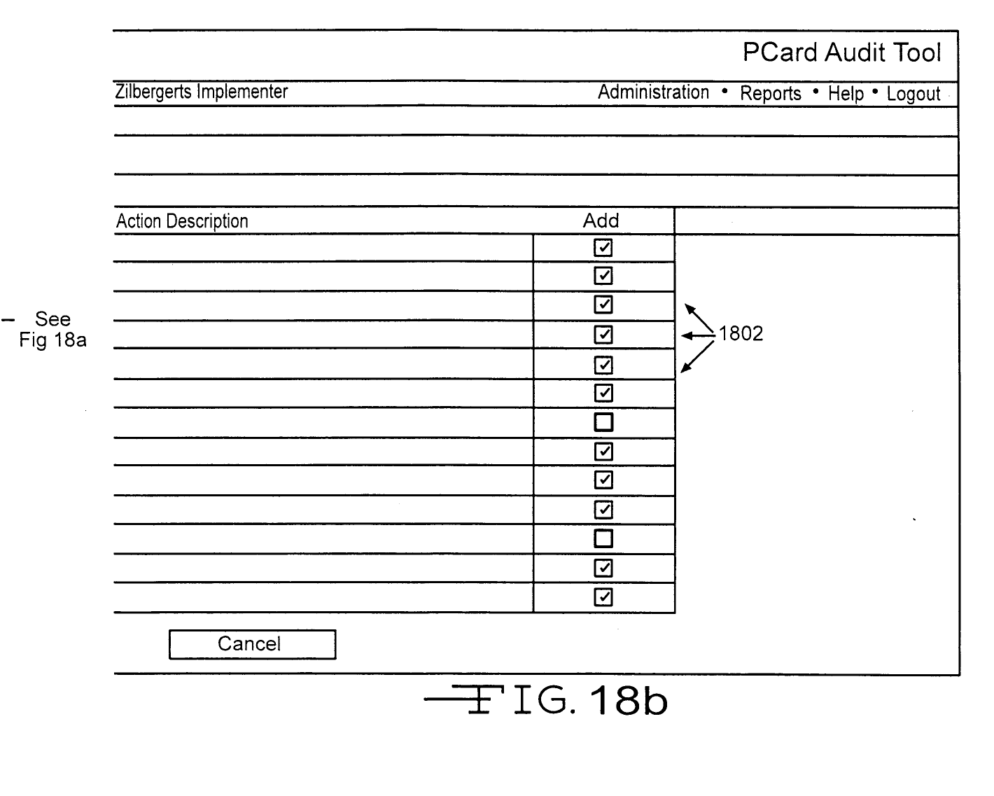

As yet a further variation which might be made to facilitate auditing using a PCard maximizer, consider the interfaces of FIGS. 17a-17b and 18a-18b. Those interfaces show how lists of questions [1701] and actions [1801] which can be used to facilitate the audit process can be defined. In FIGS. 17a-17b, an interface is shown in which a plurality of predefined questions (e.g., Q1, Q2, Q3) are shown, along with associated check boxes [1702] which can be used to select those questions. The selected questions could then be used to obtain information explaining any violation of transaction rules during an audit of purchase card transactions. Similarly, in FIGS. 18a-18b, an interface is shown in which potential responses to audit violations can be selected, for example, by using check boxes [1802]. The use of selected questions and action can facilitate auditing in a variety of manners. For example, in a circumstance in which audit responsibilities are organized into a hierarchy with two levels of review above auditors who actually examine transactions, lists of questions and actions such as could be defined using the interfaces of FIGS. 17a-17b and 18a-18b might be used to standardize information communicated throughout the hierarchy, and/or to define appropriate responses to audit violations. In practice, this might work as follows. First, if one of the transaction rules indicates that a problem exists, an auditor might review the flagged transaction and determine the cause of the violation, and to reach an appropriate proposed reaction. The cause of the violation, along with the proposed response could then be communicated to the intermediate reviewer, who could sign off on the response and explanation, or might forward the information regarding particular transactions to the final reviewer (e.g., in instances where exceptional sanctions, such as cardholder termination, are indicated). As another alternative, the reviewer could request further information about particular transactions, or might request that the auditor implement an alternate response to particular violations. Of course, other alternatives are also possible, and could be implemented without undue experimentation in light of this disclosure.

As yet a further variation which might be made to facilitate auditing using a PCard maximizer as described above, in some circumstances, a PCard maximizer might be implemented in a manner which is adapted to comprehensiveness of audits. For example, by applying predefined sets of audit rules to transaction data collected by the system, it is possible to perform a 100% automated audit on all transactions made through a purchase card program. However, in some cases, it might be desirable to avoid having a 100% automated audit. For example, there might be an internal policy which requires that a sponsor of a purchase card program manually review at least some minimum amount (e.g., 10%) of transactions during any audit. In such a case, the PCard maximizer might be configured with a rule which states the percentage (or absolute number) of records to be manually reviewed in a given period, and the system might then randomly select records for manual review until the sponsor organization's requirements had been met. As another example, in a case where a sponsor organization has a policy which includes review of certain transactions (e.g., intermediate reviewer sign off on responses to violations), the PCard maximizer might track whether the necessary review had taken place, and might issue reminders, either to the tardy reviewer, or to that individual's supervisor, when the review had not taken place within a given time period (e.g., two weeks after being reported). Further similar modifications and extensions could also be made. Thus, the discussion of auditing set forth herein should be understood as being illustrative only, and should not be treated as limiting on claims included in this application or in other applications claiming the benefit of this application.

FIG. 9 depicts an illustrative graphical user interface (GUI) screen 138 for manually inserting such selections and information, although it will be appreciated that repetitive or default settings may be loaded for one or more new customers. The configuration management mode link 140 is selected on a mode task bar 142, which also includes a data processing, end-of-cycle processing, and reporting and analysis links 144-150. The sub-page selections on the mode task bar 142 are changed to reflect the mode selected. For configuration management mode, the sub-page selections are a home key 152, a logoff key 154, a configuration key 156, a cycle maintenance key 158, a cost center management key 160, and a cardholder management key 162. In the sub-page frame 164, an example of a graphical hierarchical representation is depicted of cost centers of an organization and an approach to cost center management (e.g., relating cost centers to one another).

The sub-page selections on the mode task bar 142 are changed to reflect the mode selected. For configuration management mode, the sub-page selections are a home key 152, a logoff key 154, a configuration key 156, a cycle maintenance key 158, a cost center management key 160, and a cardholder management key 162. In a sub-page frame 164, an example of a graphical cost center hierarchical representation 166, which is presented in response to selecting cost center management mode key 160, depicts cost centers of an organization and an approach to cost center management (e.g., relating cost centers to one another). Although not depicted, another interface is presented for each sub-page selection link. For instance, selection of the configuration link 156 would also entry or modification of parameters for use in the PCard maximizer: Audit Percent Per Cycle, Audit Score Count, Audit Score Labels, Cardholder Audit Tree Level, Legend Descriptions, Mandatory Audit Cycle, Maximum Cycles Without Audit, Metric Dollar Limit, Metric Low Limit, and Metric Warning Limit.

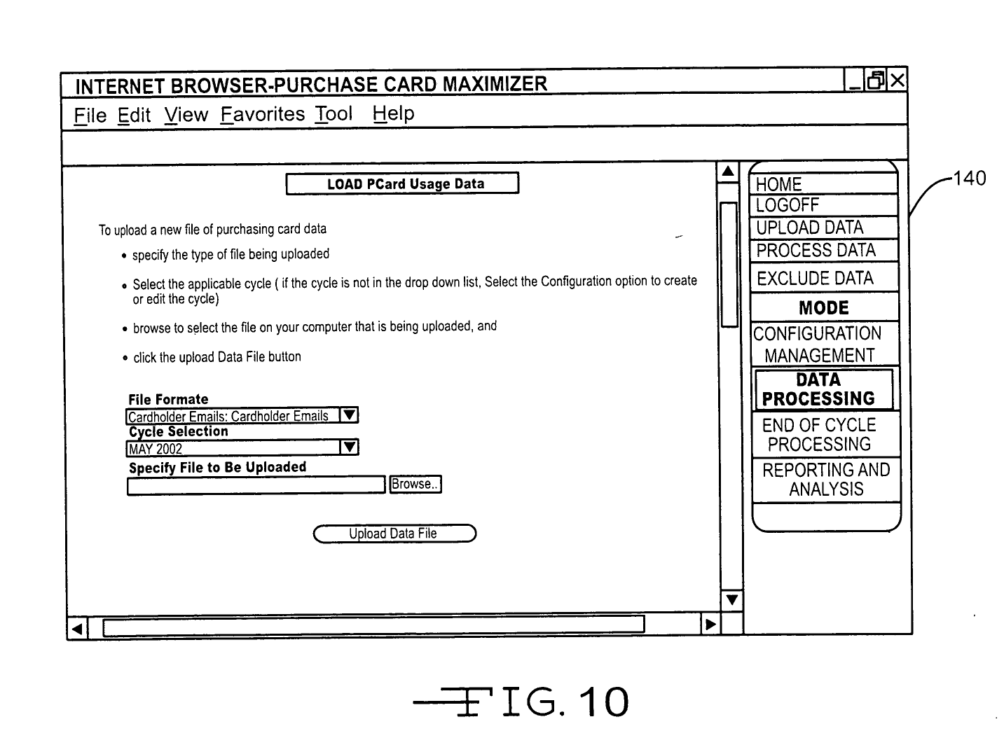

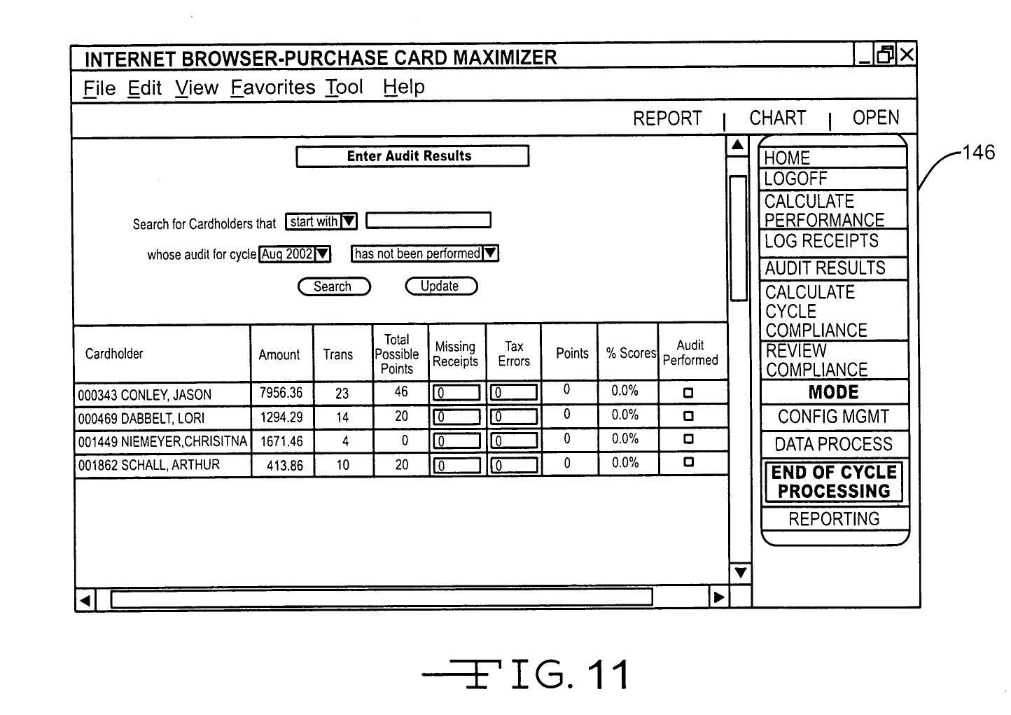

FIG. 10 depicts the GUI screen 138 wherein the data processing mode link 144 has been selected, which in turn displays a list of available sub-page selections on the task bar 142: the home link 152, the logoff link 154, an upload data link 168, a process data link 170, an exclude data link 172 and a calculate cycle performance link 174. The upload data link 168 has been selected, displaying a “Load PCard Usage Data” form 176 on the sub-page frame 164.

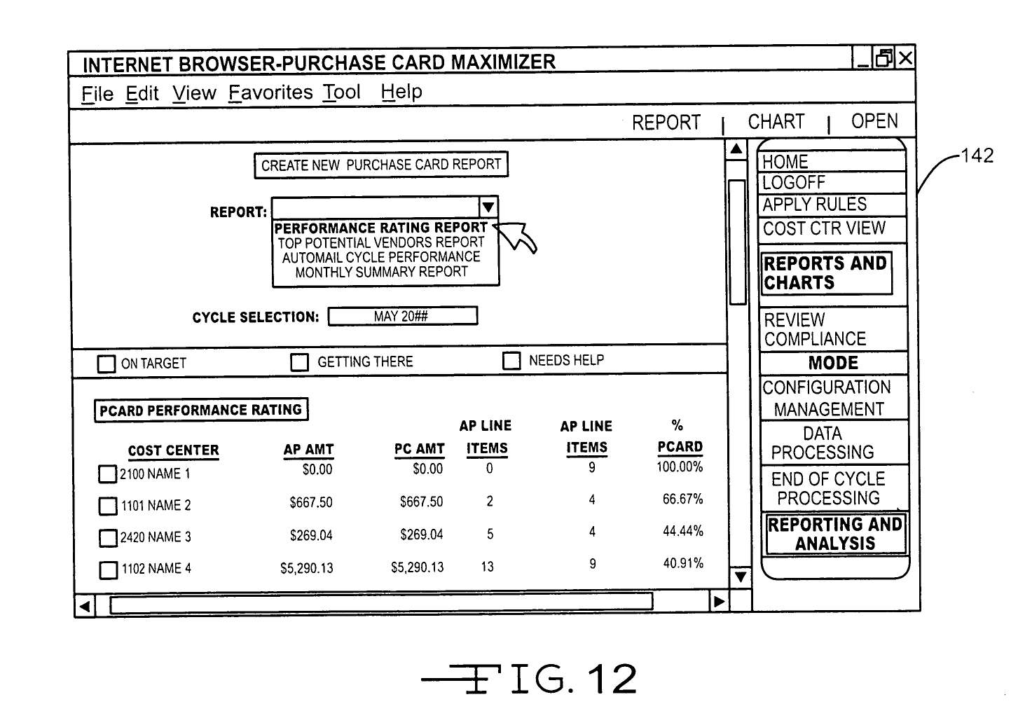

FIG. 11 depicts the GUI screen 138 wherein the recurring tasks mode link 146 has been selected, which in turn displays a list of available sub-page selections on the task bar 142: the home link 152, the logoff link 154, an apply rules link 178, a cost center view link 180, a reports and charts link 182, and a review compliance link 184. The selected reports and charts link 182 has in turn displayed a performance rating report 186 in the sub-page frame 164. Thereby, the cost centers are listed with the totaled amounts of all purchases (“AP AMT”), amounts of all purchase card transactions (“PC AMT”), the number of line items of AP transactions, the number of line items of PC transactions, and a percentage calculation of the PCard transactions as compared to total AP transactions that were not excluded for purchase card use.

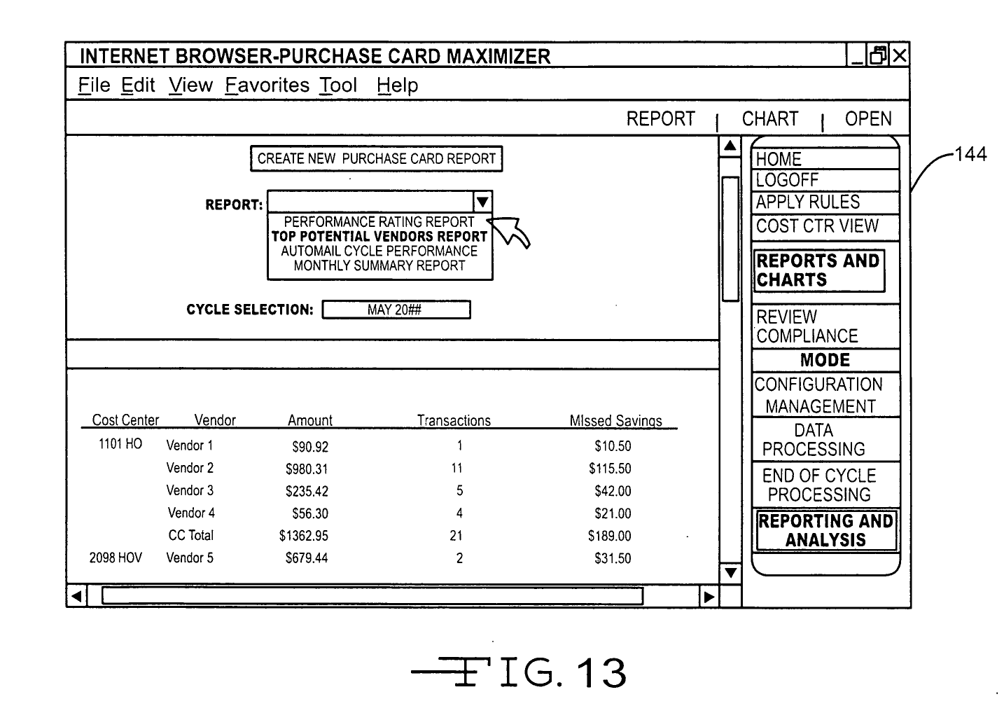

FIG. 12 depicts the GUI screen 138 with the recurring tasks mode key 146 and reports and charts link 182 selected as in FIG. 11, but further with a top potential vendors report 188 depicted in the sub-page frame 164. In particular, the total dollar amount of transactions and number of transactions are depicted of applicable procurement actions that could have been performed with a purchase account, with the corresponding missed savings tabulated.

FIG. 13 depicts the GUI screen 138 with the End-of-Cycle Processing mode key 148 selected, which in turn displays sub-page selections of the home link 152, logoff link 154, a cost center view link 198, a log receipts link 200, an audit results link 202, an audit results link 204, a calculate cycle compliance link 206, a reports and charts link 206, and a review compliance link 208. Selecting the audit results link 202 results in an “enter audit results” table 210 on the sub-page frame 164. This table 210 allows selecting a portion of the cardholders for auditing. In response to selecting a subgroup (e.g., last name beginning with “A”) and a cycle (e.g., January 2002), a listing of cardholder names, the dollar amount of their procurements, number of transactions, and count of total possible points achievable for these transactions (e.g., 2 per transaction). The customer reviews the file, inserting the number of receipts received and the number of transactions for which the tax was entered correctly. If correct in both instances for each transaction, then the total amount of points is achieved, with the percentage thereof calculated. The customer also marks that the audit was performed for tracking audit compliance.

FIG. 14 depicts the GUI screen 138 with the metric calculator mode key 150 selected, which in turn displays sub-page selections of the home link 152, the logoff link 154, a rules link 212, a create metric link 214, a load metric link 216, a delete metric link 218, and a reports link 218. Selection of the latter link results in a “PCard Metric Calculator Report” 220 being displayed on the sub-page frame 164. This report tabulates the time and expense and responsible party entailed in performing each step of the transaction in either the normal procurement process of the purchase account process. In the illustrative depiction, the categories and specific steps are as follows:

2. Perform Initial Data Load

Load List of Valid GL Codes

Load GL Data for Cycle

Load purchase card Transaction Data for Cycle

3. Set Exclusions for Cycle

Exclude Vendors that do not apply to purchase card Transactions

Exclude Cost Centers that are not participating in the purchase card program for this cycle

4. Calculate Cycle Results

Calculate purchase card performance for the cycle

Vendors that have been excluded are not included in the results

Cost centers that have been excluded area calculated, but will not be included at reporting or charting time

5. Manage Cost Center

Set cost center hierarchical display

Add new cost center to the cost center hierarchy

Edit cost center

6. Provide the tools to analyze purchase card program performance

Measure and display cost center performance for the cycle by analyzing applicable purchases through a cost center hierarchy

Compare two different cycles performance

Provide reports to highlight areas in need of improvement

7. Provide the tools to analyze Cardholder's activity

Display cardholders for the cycle by auditing current cardholders activity through a cost center hierarchy

Display filtered Cardholder list in order to obtain Logged/Non-Logged Receipts information.

Edit Configuration Parameters

Audit Percent Per Cycle

Audit Score Count

Audit Score Labels

Cardholder Audit Tree Level

Legend Descriptions

Mandatory Audit Cycle

Maximum Cycles Without Audit

Metric Dollar Limit

Metric Low Limit

Metric Warning Limit

In use, non-purchase card transaction data 16 and purchase card transaction data 14 are analyzed by a purchase card maximizer 10 for an organization, which includes excluding vendors and/or cost centers that are not applicable for purchase account use (e.g., referencing control/selection data 18). Opportunities are identified by cost center for cost savings that could be realized through increased use of a purchase account. By virtue of the foregoing, the interests of the organization are furthered by hierarchically analyzing purchase account usage for the organization.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

What is claimed is:

1. A method comprising:
a) retrieving a plurality of rules from a library, said plurality of rules comprising a rule having a parameter;
b) using an automated tool to model changes to the parameter;
c) indicating a desired value for the parameter;
d) specifying the rule as belonging to a set of audit rules; and
e) storing information in a computer readable medium indicating membership of the rule in the set of audit rules.

2. The method of claim 1 wherein the library is organized into a plurality of categories, said plurality of categories comprising:
a) transaction rules;
b) account management rules; and
c) cardholder rules
and wherein retrieving the plurality of rules from the library comprises specifying a category for the plurality of rules.

3. The method of claim 1 wherein using the automated tool to model changes to the parameter comprises:
a) indicating a data set to use for said modeling, wherein said data set comprises a set of past transactions;
b) indicating a plurality of values for said parameter; and
c) for each value from said plurality of values, indicating a number of violations of said rule for said data set.

4. The method of claim 1 further comprising:
a) defining a hierarchy comprised of a plurality of nodes;
b) associating a subset of said set of audit rules with a node from said hierarchy;
c) automatically associating said subset of said set of audit rules with each entity in the hierarchy below the node;
wherein automatically associating said subset of said set of audit rules with each entity in the hierarchy below the node comprises associating the subset of said set of audit rules with at least one entity.

5. The method of claim 4 wherein said hierarchy comprises a plurality of auditors, a first plurality of reviewers and a second plurality of reviewers, and wherein each of said auditors is below at least one reviewer from said first plurality of reviewers in the hierarchy, and wherein each reviewer from said first plurality of reviewers is below at least one reviewer from said second plurality of reviewers.

6. The method of claim 5 further comprising defining a set of questions to be asked in response to a violation of a rule from said set of audit rules, wherein defining the set of questions comprises retrieving a plurality of questions from a question library and selecting one or more questions from said plurality of questions for inclusion in said set of questions.

7. The method of claim 5 further comprising defining a set of potential responses to a violation of a rule from said set of audit rules, wherein defining the set of responses comprises retrieving a plurality of responses from a response library and selecting one or more responses from said plurality of responses for inclusion in said set of responses.

8. A method comprising:
a) receiving a plurality of purchase account transactions;
b) associating each purchase account transaction with a purchase account holder, said purchase account holder associated with a hierarchy made up of a plurality of entities;
c) associating the plurality of purchase account transactions with a plurality of audit rules based at least in part on said hierarchy;
d) identifying a set of violations by applying the plurality of audit rules to the plurality of purchase account transactions;
e) recording said set of violations; and
f) providing a violation from said set of violations to an auditor.

9. The method of claim 8 wherein said hierarchy is comprised of a plurality of auditors, and a plurality of reviewers; and wherein each auditor from said plurality of auditors is assigned to a reviewer from said plurality of reviewers.

10. The method of claim 9 further comprising allowing a reviewer to use a computerized interface to record an explanation for the violation and a response to the violation, wherein the response comprises an action from a list of actions.

11. The method of claim 10 further comprising:
a) automatically tracking each violation from said set of violations; and
b) providing a notification if a violation from the set of violations has not been explained or responded to within a predefined time period.

12. The method of claim 9 wherein each account holder from said plurality of account holders is assigned to an auditor from said plurality of auditors.

13. The method of claim 8 further comprising associating each purchase account transaction with a vendor type; wherein applying the plurality of audit rules comprises comparing a vendor type for a purchase account transaction with a set of prohibited vendor types.

14. The method of claim 8 further comprising:
a) calculating an audit score for two or more entities from the plurality of entities;
b) storing an audit record, said audit record comprising:
i) the plurality of purchase account transactions;
ii) the set of violations;
iii) an explanation for each violation from said set of violations; and
iv) a response to each violation from said set of violations;
and
c) locking the audit record.

15. The method of claim 12 further comprising:
a) indicating that one or more audit violations from a first level in the hierarchy should be escalated to a second level in the hierarchy; and
b) receiving an acknowledgement from an entity at the second level in the hierarchy of review of the one or more audit violations;
wherein the entity at the second level in the hierarchy is a reviewer, and wherein the second level is above the first level in the hierarchy.

16. The method of claim 15 further comprising indicating that one or more audit violations should be returned from the second level to the first level for further clarification.
